(19) United States
(12) Patent Application Publication
(10) Pub. No.: US 2015/0004368 A1
(43) Pub. Date: Jan. 1, 2015

(54) STRIP-SHAPED FIBER-REINFORCED COMPOSITE MATERIAL, AND A METHOD FOR PRODUCTION THEREOF

(71) Applicant: SGL CARBON SE, Wiesbaden (DE)

(72) Inventors: TIM WITZKE, MEITINGEN (DE); PATRIK-VINCENT BRUDZINSKI, MEITINGEN (DE); ANDREAS WOEGINGER, MEITINGEN (DE)

(21) Appl. No.: 14/490,897

(22) Filed: Sep. 19, 2014

Related U.S. Application Data
(63) Continuation of application No. PCT/EP2012/075166, filed on Dec. 12, 2012.

(30) Foreign Application Priority Data
Mar. 19, 2012 (DE) 102012204345.4

(51) Int. Cl. B29C 70/50; B29C 59/04; B29C 43/24

(52) U.S. Cl. CPC B29C 70/506; B29C 43/24; B29C 59/046; B29K 2101/12
USPC 428/171; 427/369; 427/365

(57) ABSTRACT

A strip-shaped fiber-reinforced composite material has a fibrous structure that is impregnated with a matrix material which contains at least one thermoplastic polymer. At least one of the large faces of the strip-shaped fiber-reinforced composite material has surface shaping. The surface shaping contains at least one indentation which extends from one of the narrow longitudinal faces of the strip-shaped fiber-reinforced composite material continuously over at least 30% of the width of the strip-shaped fiber-reinforced composite material. Furthermore, a method is performed for producing the strip-shaped, fiber-reinforced composite material.

### CROSS-REFERENCE TO RELATED APPLICATION

This is a continuation application, under 35 U.S.C. § 120, of copending international application No. PCT/EP2012/075166, filed Dec. 12, 2012, which designated the United States; this application also claims the priority, under 35 U.S.C. § 119, of German patent application No. 10 2012 204 345.4, filed Mar. 19, 2012; the prior applications are herewith incorporated by reference in their entireties.

### BACKGROUND OF THE INVENTION

1. Field of the Invention

The present invention relates to a strip-shaped fiber-reinforced composite material and to a method for producing a fiber-reinforced composite material of this type.

Fiber-reinforced composite materials are composed of a fibrous structure impregnated with a matrix material and have high strength and rigidity, in particular in the fiber direction. In addition, in comparison with other materials, such as metals, for example steel, these composite materials are distinguished by low specific weight, by low thermal expansion and by excellent thermal-shock resistance. Owing to these advantageous properties, fiber-reinforced composite materials are increasingly being used in many technical fields.

Examples of fiber-reinforced composite materials of this type are fiber-reinforced plastics materials, such as carbon-fiber-reinforced plastics materials (CFRP), which are composed of a matrix of plastics material, such as a thermoplastic polymer and/or a thermosetting polymer, in which carbon fibers or graphite fibers are embedded in one or more fibrous layers. In this case, composite materials of this type having a matrix made of one or more thermoplastic polymers can be easily processed to form a molded body having a desired shape owing to the property of thermoplastic polymers, whereby, in contrast to thermosetting polymers, they can be heated to a temperature above the melting point thereof without being destroyed. Here, thermoplastic fiber-reinforced composite materials in the form of strips or tapes are frequently produced and then portions of these strips are superposed in layers and pressed together to produce laminates having a desired shape and having desired properties adapted to the use of the molded body.

Thermoplastic strips, such as thermoplastic strips having a unidirectional carbon-fiber structure, are for example produced such that carbon fiber rovings are removed from a bobbin creel and are pulled through a pressurized cavity filled with liquid thermoplastic polymer melt. Using a method of this type, depending on the type of pressing device used, strips having a smooth surface or strips which have longitudinal grooves in the surface of the large faces thereof are obtained.

As an alternative, thermoplastic strips of this type having a unidirectional carbon-fiber structure are produced by threads being spread out to form a textile structure and being covered with a thermoplastic film, after which the fibrous bundle is impregnated with the melted-on film in a high-pressure twin-belt press. Using this method, strips having a smooth surface are obtained.

Owing to their smooth surface or surfaces having a longitudinal structure, that is to say longitudinal grooves in the surface of the large faces thereof, these strips cannot be processed to form laminates having a homogenous construction and very high quality. This is because, owing to the surfaces of the strips which are either smooth or structured in the longitudinal direction, air pockets, which inevitably form between the individual layers when a plurality of portions of the strip-shaped fiber-reinforced composite material are superposed in layers, cannot be completely expelled, and can only be expelled to an acceptable degree by lengthy pressing of the laminate, before and during the pressing of the laminate, so that there are irregular air pockets in the laminate produced which adversely affect the properties of the laminate. Furthermore, the known strip-shaped fiber-reinforced composite materials have the disadvantage of superposed portions of the strip-shaped composite material possibly slipping against one another in an uncontrolled manner, whereby the production of laminates having precisely defined geometries and layer sequences is made significantly more difficult, and in addition the fibrous structure may be damaged during the production of laminates.

### SUMMARY OF THE INVENTION

A problem addressed by the invention is therefore that of providing a strip-shaped fiber-reinforced composite material which can be processed simply and cost-effectively, and more particularly can be processed simply and cost-effectively to form a laminate made up of a plurality of layers of the superposed composite material with high homogeneity and quality and in particular without air pockets between the layers, without the individual layers slipping against one another in an uncontrolled manner during the processing thereof.

According to the invention, the problem is solved by a strip-shaped fiber-reinforced composite material which has a fibrous structure that is impregnated with a matrix material which contains at least one thermoplastic polymer. At least one of the large faces of the strip-shaped fiber-reinforced composite material has a surface shaping. The surface shaping contains at least one indentation which extends from one of the narrow longitudinal faces of the strip-shaped fiber-reinforced composite material continuously over at least 30% of the width of the strip-shaped fiber-reinforced composite material.

This solution is based on the surprising finding that in a strip-shaped fiber-reinforced composite material having a thermoplastic polymer matrix in which at least one of the large faces thereof has a surface shaping containing at least one indentation, the at least one indentation extending from one of the narrow longitudinal faces of the strip-shaped fiber-reinforced composite material continuously over at least 30% of the width of the strip-shaped fiber-reinforced composite material, air pockets which form between the individual layers when portions of the fiber-reinforced composite material are superposed are reliably and rapidly conducted away to the outside, specifically in particular when the two portions are pressed together, since the at least one indentation extends from one of the narrow longitudinal faces of the strip-shaped fiber-reinforced composite material over at least 30% of the width of the strip-shaped fiber-reinforced composite material. The indentation forms a channel between the layers of the laminate, via which the air pockets are conducted out of the lateral and central (based on the width direction of the strip) region of the strip, that is to say over a short distance—in comparison with the longitudinal grooves—and therefore with just a short period of pressing on the laminate. The air pockets between the individual layers of the composite material can thus be significantly more reliably, completely and rapidly conducted away than in the case of laminates which are formed from strip-shaped fiber-reinforced composite materials known from the prior art, which materials have smooth surfaces or surfaces having longitudinal grooves. At the same time, the surface shaping of the strip-shaped fiber-reinforced composite material ensures improved adhesion and mutual position fixing when a plurality of portions of the strip-shaped fiber-reinforced composite material are laminated onto one another, since during lamination, the shaping of the surfaces of the superposed layers can engage in one another at least in part, by which reliable position fixing of the layers which have been brought into the desired position can be ensured and the layers can be reliably prevented from slipping against one another in an uncontrolled manner. Owing to this, the strip-shaped fiber-reinforced composite material according to the invention can be processed simply and cost-effectively to form a laminate made up of a plurality of layers of the superposed composite material with high homogeneity and quality and in particular without air pockets between the layers, without the individual layers slipping against one another in an uncontrolled manner during the processing thereof, by which damage to the fibrous structure is eliminated and in addition, a laminate having a precisely defined geometry and layer sequence is obtained.

According to the invention, the strip-shaped fiber-reinforced composite material has, on at least one of its large faces, surface shaping containing at least one indentation. The at least one indentation extends from one of the narrow longitudinal faces of the strip-shaped fiber-reinforced composite material continuously over at least 30% of the width of the strip-shaped fiber-reinforced composite material. The fiber-reinforced composite material according to the present invention may not only be an end product, that is to say a finished molded body composed of the fiber-reinforced composite material, but also may be a semi-finished product, such as a prepreg.

According to a preferred embodiment of the invention, the at least one indentation in the surface shaping of the at least one large face of the strip-shaped fiber-reinforced composite material extends from one of the narrow longitudinal faces thereof continuously over at least 50%, preferably over at least 70%, more preferably over at least 80%, yet more preferably over at least 90% of the width and most preferably over the entire width of the strip-shaped fiber-reinforced composite material. In the last-mentioned case, the at least one indentation thus extends continuously from one narrow longitudinal face to the other narrow longitudinal face of the strip-shaped fiber-reinforced composite material, so that in the region of the indentation, air that is present at any point on the broad face can be rapidly and efficiently conducted away via the indentation.

In order to achieve the above-mentioned effects and advantages of the present invention, the at least one indentation in the surface shaping of the at least one large face of the strip-shaped fiber-reinforced composite material does not necessarily have to be oriented precisely perpendicularly to the longitudinal direction of the strip-shaped fiber-reinforced composite material, that is to say in the width direction of the strip-shaped fiber-reinforced composite material. Rather, the indentation can also be oriented obliquely to the width direction of the strip-shaped fiber-reinforced composite material, and for example can extend at an angle of 60° relative to the width direction of the strip-shaped composite material. This is because achieving the above-mentioned effects and advantages of the present invention does not depend on the precise alignment and orientation of the at least one indentation, but on the fact that the at least one indentation is formed and arranged such that it contains, for accelerating the rate at which air is conducted away, a path extending over at least 30% of the width of the strip-shaped fiber-reinforced composite material for conducting air present on the surface of the composite material away to one of the narrow longitudinal faces of the strip-shaped composite material, the path being shorter than the distance that the air would have to travel to get to one of the longitudinal ends of the strip-shaped fiber-reinforced composite material. Nevertheless, it is preferable for the at least one indentation to have as small an angle as possible relative to the width direction of the strip-shaped composite material, since the path formed by the indentation from the center of the composite material to the narrow longitudinal face(s) thereof is thus particularly short.

Therefore, in a development of the concept of the invention, it is proposed that the at least one indentation extends—relative to the width direction of the strip-shaped composite material—at an angle of less than 90°, preferably of at most 60°, more preferably of at most 45°, more preferably of at most 30°, yet more preferably of at most 15° and most preferably of 0° or extends—relative to the longitudinal direction of the strip-shaped composite material—at an angle of less than 0°, preferably of at least 30°, more preferably of at least 45°, more preferably of at least 60°, yet more preferably of at least 75° and most preferably of 90°. In the case of the at least one indentation not being precisely perpendicular to the longitudinal direction of the strip-shaped composite material, an extension of the indentation over at least 30% of the width of the strip-shaped fiber-reinforced composite material is understood to mean that the length of the indentation, projected onto the width of the strip-shaped composite material, is at least 30% of the width of the strip-shaped fiber-reinforced composite material starting from one of the narrow longitudinal faces of the strip-shaped composite material.

It is ensured that the air present on the surface of the composite material is particularly efficiently conducted away if the at least one indentation in the surface shaping of the at least one large face of the strip-shaped fiber-reinforced composite material, when the indentation is viewed in cross section, has, at each point of its longitudinal extension, a depth of at least 2.5 μm, preferably of at least 5 μm, more preferably of at least 7.5 μm, more preferably of at least 10 μm, yet more preferably of at least 12.5 μm and most preferably of at least 15 μm, for example of approximately 20 μm. Indentations of this type are particularly suitable for preventing closed or at least largely closed cavities in the surface shaping of the composite material when two portions of the strip-shaped fiber-reinforced composite material are laminated onto one another, and thus are suitable for ensuring that air is conducted away efficiently. In this case, the depth of the indentation is defined as the distance between the lowest (when the indentation is viewed in cross section) point of the indentation and the highest point of the region surrounding the indentation, the highest point of the region surrounding the indentation being the highest point of the region, surrounding the above-mentioned deepest point in a circular manner with a radius of 1 cm, of the surface of the shaping of the large face of the strip-shaped fiber-reinforced composite material.

The depth is not limited in the upward direction, it however generally being sufficient for the at least one indentation in the surface shaping of the at least one large face of the strip-shaped fiber-reinforced composite material, when the indentation is viewed in cross section, to have, at each point of its longitudinal extension, a depth of at most 100 μm, preferably of at most 50 μm and more preferably of at most 25 μm.

In principle, the at least one indentation may have any desired cross-sectional shape, that is to say for example also a polygonal cross-sectional shape. However, good results are obtained in particular if the at least one indentation has a U-shaped, V-shaped, rectangular or square cross section.

Preferably, the at least one indentation in the surface shaping, based on the base plane of the surface shaping, is surrounded by at least two elevations. Here, the term “base plane” describes the horizontal plane which lies furthest in the direction of the surface of the strip and extends through the entire cross-sectional area of the strip without intersecting the surface shaping. The height of an elevation in the surface shaping is accordingly defined as the distance of the uppermost point, that is to say the outermost point in the vertical direction of the strip-shaped fiber-reinforced composite material, of the elevation from the point vertically therebelow on the base plane of the strip.

According to a further particularly advantageous embodiment of the present invention, the at least two elevations are arranged at regular intervals. Surface shaping of this type ensures that air is reliably and uniformly conducted away over the entire surface of the strip-shaped fiber-reinforced composite material. In addition, it is also ensured that a plurality of superposed portions of the strip-shaped fiber-reinforced composite material engage in one another, by which reliable position fixing of the layers which have been brought into the desired position can be ensured and the layers can be reliably prevented from slipping against one another in an uncontrolled manner. For example, in this embodiment, the elevations can be arranged in a periodic pattern relative to one another. Likewise, the at least one indentation and the surface shaping can collectively form a periodic pattern.

Air can be conducted away efficiently and substantially uniformly all over in particular if the surface shaping has 1 to 2,000, preferably 5 to 1,000, more preferably 10 to 500, yet more preferably 30 to 300 and most preferably 50 to 200 elevations per cm² surface area, for example 100 elevations per cm² surface area.

Surface shaping which is particularly suitable for conducting air away and is also simple to produce and effective engagement of superposed layers of the strip-shaped composite material are also achieved if at least some of the elevations are ellipsoid and particularly preferably at least substantially hemispherical. In this embodiment, it is yet more preferable for the elevations to be arranged in the form of a two-dimensional hexagonal or cubic layer of spheres, and preferably in the form of a dense two-dimensional hexagonal or cubic layer of spheres. In the case of a dense two-dimensional hexagonal layer of spheres, each elevation is surrounded by six very close adjacent elevations, which, when viewed in the plane parallel to the large face, all have substantially the same distance from the elevation. In the case of a dense two-dimensional cubic layer of spheres, the elevations are arranged in a square pattern, that is to say each elevation is surrounded by eight very close adjacent elevations.

Particularly advantageous air-conducting and position-fixing properties of the strip-shaped fiber-reinforced composite material are also achieved if the distance between two adjacent elevations and/or indentations in the surface shaping of the strip-shaped composite material is between 0.1 and 50 mm, preferably between 0.5 and 10 mm, more preferably between 1 and 5 mm and most preferably between 1.5 mm and 2.5 mm.

Preferably, the surface shaping of the strip-shaped fiber-reinforced composite material, when the fiber-reinforced composite material is viewed in longitudinal section and/or in cross section, has a periodic shape at least in portions. In this way, air can be conducted away efficiently and in a manner which is uniform all over and good engagement between superposed layers of the composite material can be achieved, so that portions of the strip-shaped fiber-reinforced composite material configured in this way can be laminated onto one another in various orientations relative to one another with effective fixing of the relative position of the portions. In this case, the surface shaping may preferably be substantially sinusoidal, but may also have another periodic shape, for example may be periodically wave-shaped or periodically meandering.

In the above-mentioned embodiment, the period of the periodic shape of the surface shaping is for example between 0.1 mm and 50 mm, preferably between 0.5 and 10 mm, more preferably between 1 and 5 mm and most preferably between 1.5 mm and 2.5 mm.

Alternatively or additionally, the amplitude of the periodic shape of the surface shaping is for example at least 1.25 μm, preferably at least 2.5 μm, more preferably at least 3.75 μm, more preferably at least 5 μm, yet more preferably at least 6.25 μm and most preferably at least 7.5 μm. In this context, half of the distance between the highest and lowest (when the strip-shaped fiber-reinforced composite material is viewed in the vertical direction) point of one period of the surface shaping is referred to as the amplitude.

As an alternative to the above-mentioned embodiment, in which the surface shaping, when the fiber-reinforced composite material is viewed in longitudinal section and/or in cross section, has a periodic shape at least in portions, the surface shaping may in principle also have a non-periodic shape at least in portions. Irrespective of whether the surface shaping, when the fiber-reinforced composite material is viewed in longitudinal section and/or in cross section, has a periodic shape or a non-periodic shape at least in portions, good results are achieved if the surface shaping, when the fiber-reinforced composite material is viewed in longitudinal section and/or in cross section, is sinusoidal, zigzag-shaped, wave-shaped, for example square-wave-shaped, or meandering at least in portions, a sinusoidal configuration of the indentation being particularly preferred.

In principle, the fibrous structure provided in the strip-shaped fiber-reinforced composite material can have any structure known to a person skilled in the art. For example, the fibrous structure may be selected from the group consisting of fibrous webs, non-woven fabrics, woven fabrics, knitted fabrics, felts and any combination of two or more of the above-mentioned structures. In this case, good results are in particular achieved if the fibrous structure is a unidirectional fibrous structure. Particularly preferred examples of a unidirectional fibrous structure of this type are unidirectional non-woven fabrics and unidirectional woven fabrics. Fibrous structures of this type are particularly suitable for producing strip-shaped fiber-reinforced composite materials having a high mechanical loading capacity, and specifically in the longitudinal direction of the fibers in particular.

A versatile strip-shaped fiber-reinforced composite material having advantageous mechanical properties is for example achieved if the fibrous structure is composed of a fiber/fibers which is/are selected from the group consisting of carbon fibers, ceramic fibers, glass fibers and any combination of two or more of the above-mentioned fibers. The fibrous structure is particularly preferably composed of carbon fibers, since they have a particularly high tensile strength.

Preferably, the fibers are present in the fibrous structure in the form of continuous fibers. In this case, the diameter of the fiber(s) is 0.1 to 100 μm, preferably 0.5 to 50 μm and more preferably 1 to 10 μm, and may for example be approximately 7 μm.

A suitable fibrous structure preferably has a fiber mass per unit area of between 5 and 1,000 g/m², preferably of between 20 and 500 g/m², more preferably of between 35 and 350 g/m² and most preferably of between 50 and 200 g/m².

Particularly good properties of the strip-shaped fiber-reinforced composite material are also achieved if the material has a fiber volume content of between greater than 0% and 70%, preferably of between 20% and 70%, more preferably of between 30% and 70%, yet more preferably of between 40% and 60% and most preferably of between 45% and 55%. For example, a strip-shaped fiber-reinforced composite material having a fiber volume content of approximately 50% has both good mechanical flexibility and loading capacity. In this case, the fiber volume content refers to the proportion of the volume filled by the fibrous material of the total volume of the strip-shaped fiber-reinforced composite material.

Furthermore, the strip-shaped fiber-reinforced composite material preferably has a thickness of between 0.01 mm and 1 cm, preferably of between 0.03 mm and 2 mm, more preferably of between 0.05 mm and 1 mm, yet more preferably of between 0.08 mm and 0.5 mm and most preferably of between 0.1 and 0.3 mm.

The width of the strip-shaped fiber-reinforced composite material may for example be in the range of between 1 mm and 10 m, preferably of between 10 mm and 1 m, more preferably of between 100 mm and 100 cm, yet more preferably of between 1 cm and 50 cm and most preferably of between 10 cm and 30 cm, for example a width of approximately 20 cm leading to a particularly versatile strip-shaped fiber-reinforced composite material.

Depending on the specific use of the strip-shaped fiber-reinforced composite material, it may have a mass per unit area of between 10 and 2,000 g/m², preferably of between 40 and 1,000 g/m², more preferably of between 70 and 700 g/m² and most preferably of between 100 and 400 g/m².

Preferably, the matrix material of the strip-shaped fiber-reinforced composite material consists of a thermoplastic polymer or of a mixture of two or more thermoplastic polymers, that is to say that, except for one or more thermoplastic polymers, the matrix does not comprise any additional components, and in particular does not comprise a thermosetting polymer or an elastomer. Suitable thermoplastic polymers include, for example, polyester, polyolefins, polyamides, polystyrenes, polyvinyl chlorides, polyacrylonitriles, polyacrylates, polycarbonates, polyether ketones, polyethersulfones, polysulfones, polyimides, polyvinyl acetals and acrylonitrile butadiene styrenes.

Particularly advantageous properties of the strip-shaped fiber-reinforced composite material are achieved if it is substantially completely impregnated. For this purpose, the strip-shaped fiber-reinforced composite material preferably has a void content of at most 15%, preferably of at most 10%, more preferably of at most 7%, yet more preferably of at most 5% and most preferably of at most 3%. In this case, the void content is measured according to DIN EN 2564. Accordingly, the shaped surface of the at least one large face is preferably formed at least substantially completely by the matrix material of the strip-shaped fiber-reinforced composite material at least in the region of the at least one indentation.

Furthermore, the present invention relates to a laminate which contains at least two superposed layers of an above-mentioned strip-shaped fiber-reinforced composite material.

Further subject matter of the present invention is a method for producing a strip-shaped fiber-reinforced composite material. The method includes:
a) providing a fibrous structure,
b) impregnating the fibrous structure with a matrix material which contains at least one thermoplastic polymer, and
c) providing surface shaping in the surface of at least one of the large faces of the strip-shaped fiber-reinforced composite material, the surface shaping containing at least one indentation which extends from one of the narrow longitudinal faces of the strip-shaped fiber-reinforced composite material continuously over at least 30% of the width of the strip-shaped fiber-reinforced composite material.

Using the method according to the invention, a strip-shaped fiber-reinforced composite material according to the invention as described above can be produced. The advantages and preferred embodiments described in relation to the strip-shaped fiber-reinforced composite material also apply similarly to the method.

In order to achieve a particularly uniform fibrous structure, in particular in respect of the fiber density, the fiber distribution and the fiber alignment, in a development of the concept of the invention it is proposed that the fibrous structure be spread out before impregnation. In this case, “spreading out the fibrous structure” is understood to mean that the fibrous structure, such as a fiber roving, is widened in its width direction, that is to say is given a wider cross section. By spreading the structure out in this manner, the distribution of the fibers in the fibrous structure can be evened out and the degree to which the fibers are aligned in the longitudinal direction of the fibrous structure can be increased. The structure can be spread out such that the width of the fibrous structure is increased, based on the original width, by at least 30%, preferably by at least 50%, more preferably by at least 100%, yet more preferably by at least 150% and most preferably by at least 200%.

The at least one thermoplastic polymer is preferably applied to both sides of the fibrous structure before the fibrous structure is impregnated with the thermoplastic polymer. In this case, the at least one thermoplastic polymer can advantageously be scattered onto the fibrous structure as a powder or granulated material before impregnation, and specifically using a powder scattering unit, for example.

According to a preferred embodiment of the present invention, the thermoplastic polymer, which is applied for example as a powder or granulated material, is melted on before impregnation, that is to say the surface of the thermoplastic polymer particles is only briefly melted on so that the thermoplastic polymer particles adhere to the surface of the fibrous structure during subsequent cooling and are fixed thereby to the fibrous structure. Melting on of this type may be achieved particularly well in a radiation field, for example in an infrared radiation field, since the field makes particularly rapid and well-regulated heating possible.

The fibrous structure can in principle be impregnated with the thermoplastic polymer according to method step b) in any known manner of impregnation, for example by pultrusion, in which the fibrous structure is drawn through a nozzle filled with the thermoplastic polymer. In an alternative, the impregnation may also take place using twin-belt presses, more particularly high-pressure and/or low-pressure twin-belt presses. Likewise, it is however also possible to impregnate the fibrous structure with the thermoplastic polymer by calendering, that is to say by the fibrous structure being guided through a calendering tool which contains one or more pairs of calendering rolls.

According to a further advantageous embodiment, making the surface shaping in the surface of the at least one large face of the strip-shaped composite material includes a surface-shaped pressing tool being pressed against the surface of the strip-shaped fiber-reinforced composite material. In this case, the structuring is achieved by the press tool. The press tool may contain a pair of rolls, a press plate, a press punch, a press belt, a press insert or press paper.

The above-mentioned method steps a), b) and c) of providing the fibrous structure, of impregnating the fibrous structure with the thermoplastic polymer and of providing the surface shaping can be carried out both in a continuous and in a discontinuous process. In this case, the individual method steps, and in particular method steps b) and c), can be carried out successively or simultaneously. Preferably, the surface shaping according to method step c) is made in the strip-shaped fiber-reinforced composite material during the impregnation according to method step b), that is to say that method steps b) and c) take place simultaneously, and specifically by leading the composite material through one or more pairs of rolls, for example.

The above-described strip-shaped fiber-reinforced composite material is outstandingly suitable for producing laminates by superposing and pressing a plurality of portions of the strip-shaped fiber-reinforced composite material, air pockets present between the layers being expelled, owing to the surface shaping described, significantly more rapidly and reliably than in known composite materials, and the strip portions being prevented from slipping against one another in an uncontrolled manner. The laminates obtained in this way therefore have advantageous properties and at the same time can be produced particularly rapidly and cost-effectively.

Other features which are considered as characteristic for the invention are set forth in the appended claims.

Although the invention is illustrated and described herein as embodied in a strip-shaped fiber-reinforced composite material, and a method for production thereof, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of an embodiment of a longitudinal portion of a strip-shaped fiber-reinforced composite material according to the invention;

FIG. 2 is a perspective view of detail A of the strip-shaped fiber-reinforced composite material according to the invention from FIG. 1;

FIG. 3 is a plan view of the detail A from FIGS. 1 and 2;

FIG. 4 is a section view taken along line IV-IV from FIG. 3 of the detail A from FIGS. 1 to 3;

FIG. 5 is a plan view of another, larger detail of the strip-shaped fiber-reinforced composite material according to the invention; and

FIG. 6 shows a system for carrying out a method according to the invention for producing the strip-shaped fiber-reinforced composite material according to the invention.

### DETAILED DESCRIPTION OF THE INVENTION

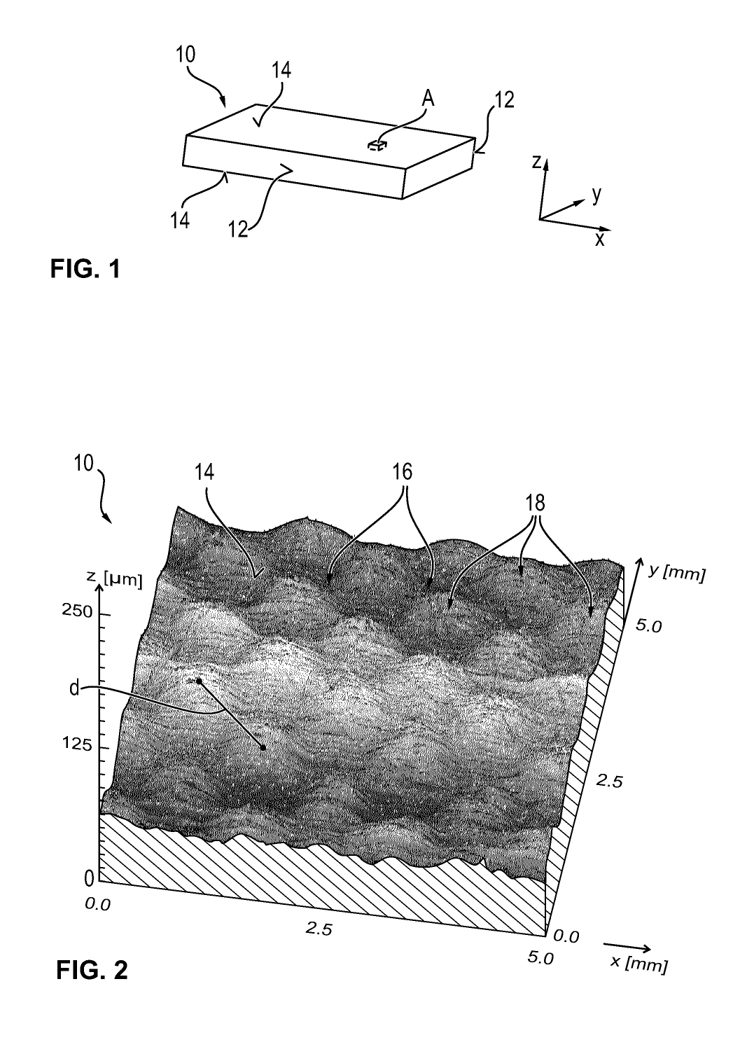

Referring now to the figures of the drawings in detail and first, particularly to FIG. 1 thereof, there is shown a perspective view of a longitudinal portion of a fiber-reinforced composite material according to the invention, which portion extends in a longitudinal direction x and is delimited in a width direction y by two narrow longitudinal faces 12 and in a vertical direction z of the strip-shaped fiber-reinforced composite material 10 by two large faces 14.

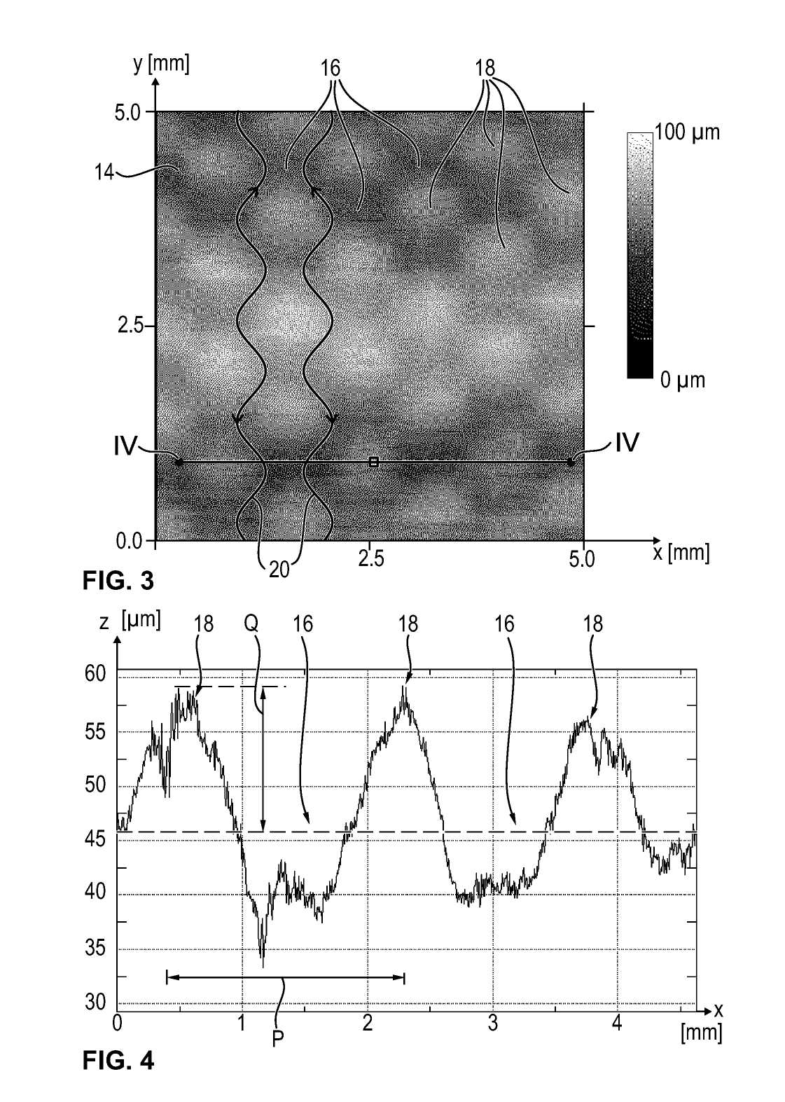

FIGS. 2 and 3 are a perspective view and a plan view respectively of a detail A of the strip-shaped fiber-reinforced composite material 10 according to the invention from FIG. 1. In this case, FIGS. 2 and 3 show in particular the shaped surface of one of the large faces 14 of the strip-shaped fiber-reinforced composite material 10. The dimensioned coordinate axes in the drawings in FIGS. 2 and 3 show the dimensions in the longitudinal direction x, in the width direction y and in the vertical direction z of the strip-shaped fiber-reinforced composite material 10.

The surface shaping of the large face 14 contains an indentation 16 which extends from one of the narrow longitudinal faces 12 (not shown in the detail in FIGS. 2 and 3) of the strip-shaped fiber-reinforced composite material 10 continuously over at least 30% of the width of the strip-shaped fiber-reinforced composite material 10. Owing to the indentation 16, air present on the surface 14 can be conducted away in the width direction y, and thus over a short distance and in an accordingly short amount of time, to the narrow longitudinal faces 12 of the composite material 10, even if a plurality of portions of a strip-shaped fiber-reinforced composite material 10 as shown in FIG. 2 are superposed, by which it is possible to press the portions to form a laminate in less time and with air pockets between the various portions, forming the layers of the laminate, of the strip-shaped fiber-reinforced composite material 10 being reliably prevented.

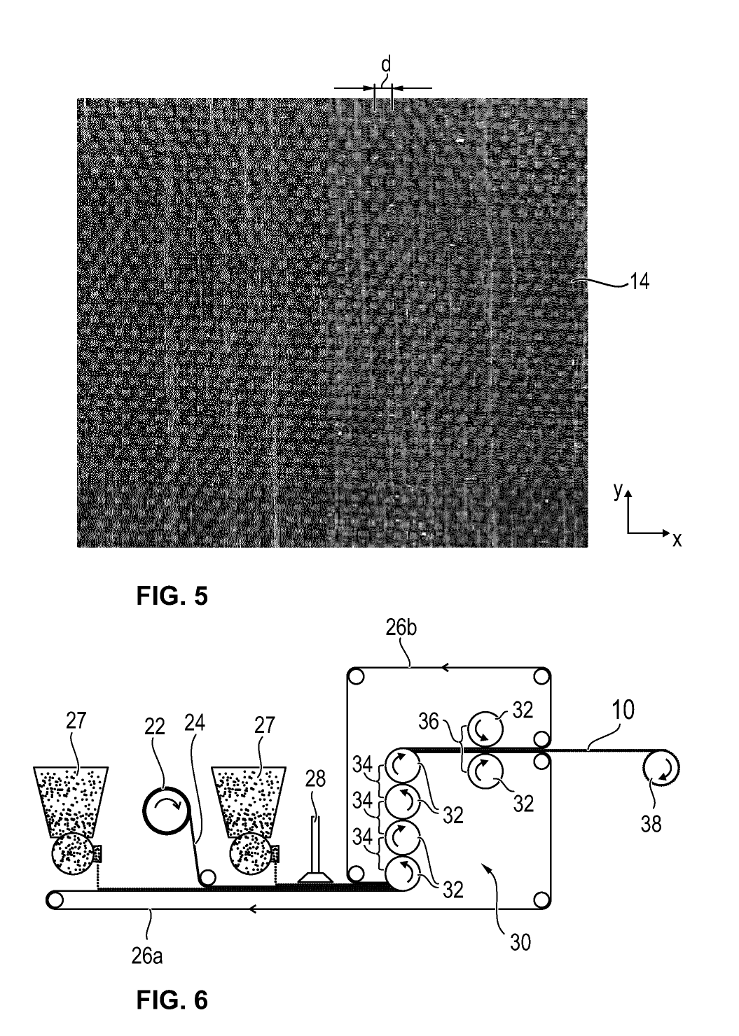

The surface shaping contains a plurality of elevations 18 which surround the at least one indentation 16 and are arranged at regular intervals in the present embodiment. Specifically, the elevations 18 are substantially ellipsoid and are arranged in the form of a two-dimensional hexagonal layer of spheres which at least approximately corresponds to a dense two-dimensional hexagonal layer of spheres, as can also be seen in particular in the plan view in FIGS. 3 and 5. In this case, each elevation 18 is surrounded by six further elevations 18 which are arranged in a hexagon and are all at least approximately the same distance d from the central elevation 18, the distance d being approximately 2 mm in the present embodiment.

FIG. 4 is a longitudinal section of the surface shaping from FIGS. 2 and 3 taken along the line VI-VI from FIG. 3. As can be seen in FIG. 4, when viewed in longitudinal section, the surface shaping is approximately sinusoidal, a period P of the sinusoidal shape being approximately 2 mm and the amplitude Q thereof being approximately 10 μm. Also in the cross section (not specifically shown in the drawings) in the width direction y, the surface shaping shown in FIGS. 2 and 3 is at least approximately sinusoidal.

FIG. 5 is a plan view of a somewhat larger detail of the surface shaping from FIGS. 2 to 4, in which the regular hexagonal arrangement of the elevations 18 can also be seen. In the present embodiment, the surface shaping has approximately 60 elevations per cm² surface area, the surface area being based on the base plane of the strip-shaped fiber-reinforced composite material 10, that is to say on the plane spanned by the longitudinal direction x and the width direction y of the strip-shaped fiber-reinforced composite material 10.

The surface shaping shown in FIGS. 2 to 5 is particularly well suited to rapidly and reliably conducting air trapped between two portions, which are laminated onto one another, of a strip-shaped fiber-reinforced composite material 10 as shown in FIGS. 1 to 5 away to the narrow longitudinal faces 12 (FIG. 1) and thus out of the intermediate space between the two portions, and specifically to conducting the air away uniformly over the entire surface of the large face 14. FIG. 3 shows a plurality of paths 20 by way of example, via which the air can escape from the center of the strip-shaped fiber-reinforced composite material 10 towards the narrow longitudinal faces 12.

The surface shaping shown in FIGS. 2 to 5 is also suitable for fixing a plurality of portions of a strip-shaped fiber-reinforced composite material 10, as shown in FIGS. 1 to 5, to one another when the large faces 14 of the portions are superposed, since the regular surface shaping of the superposed large faces at least approximately interlock, whereby the two portions are prevented from slipping against one another in an uncontrolled manner. Owing to the shape of the surface shaping, the two portions do not only at least approximately interlock when the two portions are superposed in parallel, that is to say in parallel longitudinal alignment, but also when the two portions are superposed in a longitudinal alignment which is rotated about the vertical direction z by 45° or by 90° relative to the parallel alignment.

FIG. 6 shows a system for carrying out a method according to the invention for producing the strip-shaped fiber-reinforced composite material. In the present embodiment, the method is carried out continuously. A fibrous structure 24 is provided via an unwinding roll 22 and is laid on a first conveyor belt 26a which guides the fibrous structure 24 through the system. Two powder scattering units 27 apply the thermoplastic polymer, provided in powder form, to the fibrous structure 24, specifically on one hand by the top of the fibrous structure 24 being directly scattered with the thermoplastic polymer powder and on the other hand indirectly by the top of the first conveyor belt 26a being scattered with the thermoplastic polymer powder before the conveyor belt 26a comes into contact with the underside of the fibrous structure 24, so that the thermoplastic polymer powder is applied to both sides of the fibrous structure 24.

The fibrous structure 24 covered on both sides with the thermoplastic polymer powder is then guided into the radiation field of an infrared radiator 28 in the conveying direction, in which field the particles of the thermoplastic polymer powder are heated and melted on by the radiation field such that, after the cooling that takes place downstream of the infrared radiator 28, the particles adhere to the fibers of the fibrous structure 24 because the melted-on particle surface solidifies.

In the conveying direction, downstream of the infrared radiator 28, a second conveyor belt 26b is guided onto the fibrous structure 24 from above, so that the fibrous structure 24 is received and guided between the two conveyor belts 26a, 26b. Downstream thereof in the conveying direction, the fibrous structure 24 is guided through a calendering tool 30. The calendering tool 30 contains four calendering rolls 32, which together form three pairs of calendering rolls 34, the fibrous structure 24 being guided through the pairs of calendering rolls 34 and having pressure and heat applied thereto at this point, by which the fibrous structure 24 is impregnated with the thermoplastic polymer. Downstream thereof in the conveying direction, the calendering tool 30 contains yet another pair of calendering rolls 36, in which pressure and cold are applied to the fibrous structure 24, by which the thermoplastic polymer matrix material which impregnates the fibrous structure 24 is solidified. In the present embodiment, the surface shaping is made in the surface of the strip-shaped fiber-reinforced composite material 10 by suitably shaped pairs of calendering rolls 34, 36.

Finally, the conveyor belts 26a, 26b are removed from the fibrous structure 24 and the finished fiber-reinforced composite material 10 is wound onto a winding roll 38.

The following is a summary list of reference numerals and the corresponding structure used in the above description of the invention:
10 strip-shaped fiber-reinforced composite material
12 narrow longitudinal face of the composite material
14 large face of the composite material
16 indentation in the surface shaping
18 elevation in the surface shaping
20 path for conducting air away
22 unwinding roll
24 fibrous structure
26a, b conveyor belt
27 powder scattering unit
28 infrared radiator
30 calendering tool
32 calendering roll
34, 36 pair of calendering rolls
38 winding roll
A detail
d distance between two elevations
P period
Q amplitude
x, y, z longitudinal, width and vertical directions

1. A strip-shaped fiber-reinforced composite material, comprising:
a fibrous structure impregnated with a matrix material containing at least one thermoplastic polymer, said fibrous structure having larger faces and narrower longitudinal faces, at least one of said larger faces having a surface shaping, said surface shaping containing at least one indentation extending from one of said narrower longitudinal faces continuously over at least 30% of a width of the strip-shaped fiber-reinforced composite material, said fibrous structure being a unidirectional fibrous structure, the strip-shaped fiber-reinforced composite material having a thickness of between 0.03 mm and 2 mm, said at least one indentation, when said indentation is viewed in cross section, has, at each point of a longitudinal extension, a depth of at least 2.5 μm, and said at least one indentation, when said indentation is viewed in cross section, having, at each point of said longitudinal extension, said depth of at most 100 μm.

2. The strip-shaped fiber-reinforced composite material according to claim 1, wherein said at least one indentation extends from one of said narrower longitudinal faces continuously over at least 50% of said width.

3. The strip-shaped fiber-reinforced composite material according to claim 1, wherein said surface shaping has elevations, said at least one indentation in said surface shaping, based on a base plane of said surface shaping, is surrounded by at least two of said elevations.

4. The strip-shaped fiber-reinforced composite material according to claim 3, wherein said surface shaping has 1 to 2,000 of said elevations per cm² surface area.

5. The strip-shaped fiber-reinforced composite material according to claim 3, wherein at least some of said elevations are ellipsoid, and said elevations are disposed in a form of a two-dimensional hexagonal spheres or a cubic layer of spheres.

6. The strip-shaped fiber-reinforced composite material according to claim 1, wherein said surface shaping, when the strip-shaped fiber-reinforced composite material is viewed in a longitudinal section and/or in cross section, is sinusoidal, zigzag-shaped, wave-shaped or meandering at least in portions.

7. The strip-shaped fiber-reinforced composite material according to claim 1, wherein said fibrous structure is composed of at least one fiber which is selected from the group consisting of carbon fibers, ceramic fibers, glass fibers and any combinations of at least two of the above-mentioned fibers.

8. The strip-shaped fiber-reinforced composite material according to claim 1, wherein said fibrous structure has a fiber mass per unit area of between 5 and 1,000 g/m².

9. The strip-shaped fiber-reinforced composite material according to claim 1, wherein said matrix material consists of a thermoplastic polymer or of a mixture of at least two thermoplastic polymers.

10. The strip-shaped fiber-reinforced composite material according to claim 1, wherein the strip-shaped fiber-reinforced composite material has a void content of at most 15%.

11. The strip-shaped fiber-reinforced composite material according to claim 1, wherein:
said fibrous structure has a thickness of between 0.05 mm and 1 mm;
said depth of said at least one indentation at each point of said longitudinal extension is at least 15 μm; and
said depth of said at least one indentation at each point of said longitudinal extension is at most 25 μm.

12. The strip-shaped fiber-reinforced composite material according to claim 3, wherein at least some of said elevations are at least substantially hemispherical, and said elevations are disposed in a form of a dense two-dimensional hexagonal spheres or cubic layer of spheres.

13. The strip-shaped fiber-reinforced composite material according to claim 1, wherein said fibrous structure has a fiber mass per unit area of between 50 and 200 g/m².

14. The strip-shaped fiber-reinforced composite material according to claim 1, wherein the strip-shaped fiber-reinforced composite material has a void content of at most 3%.

15. A method for producing a strip-shaped fiber-reinforced composite material, which comprises the steps of:
providing a fibrous structure;
impregnating the fibrous structure with a matrix material having at least one thermoplastic polymer; and
providing surface shaping in a surface of at least one of large faces of the strip-shaped fiber-reinforced composite material, the surface shaping containing at least one indentation extending from one of narrow longitudinal faces of the strip-shaped fiber-reinforced composite material continuously over at least 30% of a width of the strip-shaped fiber-reinforced composite material.

16. The method according to claim 15, which further comprises spreading out the fibrous structure before performing the impregnating step.

17. The method according to claim 15, which further comprises guiding the fibrous structure through a calendering tool to impregnate the fibrous structure with the thermoplastic polymer.

18. The method according to claim 15, wherein performance of the surface shaping includes pressing a surface-shaped press tool against a surface of the strip-shaped fiber-reinforced composite material.

19. The method according to claim 15, wherein the surface shaping step is performed on the strip-shaped fiber-reinforced composite material during the impregnating step.
